(19) United States
(12) Patent Application Publication
(10) Pub. No.: US 2014/0305595 A1
(43) Pub. Date: Oct. 16, 2014

(54) APPARATUS FOR PREVENTING CURL IN BOTTOM PROTECTING FILM FOR DISPLAY DEVICE

(71) Applicant: Samsung Display Co., Ltd., Yongin-City (KR)

(72) Inventor: Jin-Koo KANG, Yongin-City (KR)

(21) Appl. No.: 14/136,866

(22) Filed: Dec. 20, 2013

(30) Foreign Application Priority Data
Apr. 12, 2013 (KR) 10-2013-0040649

(51) Int. Cl. B32B 37/00

(52) U.S. Cl. CPC B32B 37/0046
USPC 156/580

(57) ABSTRACT

Disclosed is an apparatus for preventing a curl in a bottom protecting film for a display device. The apparatus includes a working table on which the bottom protecting film is mounted, and a plurality of pressing apparatuses which is spaced apart from the working table and presses an edge part of the bottom protecting film. The plurality of pressing apparatuses includes a corner pressing apparatus which presses a corner part of the edge part of the bottom protecting film and a side pressing apparatus which presses a longitudinal side part of the edge part of the bottom protecting film.

### CLAIM OF PRIORITY

This application makes reference to, incorporates into this specification the entire contents of, and claims all benefits accruing under 35 U.S.C. §119 from an application earlier filed in the Korean Intellectual Property Office on Apr. 12, 2013, and there duly assigned Serial No. 10-2013-0040649.

### BACKGROUND OF THE INVENTION

1. Field of the Invention

Embodiments of the present invention generally relate to an apparatus for preventing a curl in a bottom protecting film for a display device, and more particularly, to an apparatus for preventing a curl in a bottom protecting film for a display device by holding an edge portion of the bottom protecting film on a working table.

2. Description of the Related Art

In order to apply display devices, such as an organic light emitting diode (OLED) display, a liquid crystal display (LCD), and the like, to various applications, the display devices may be manufactured to be thin or easily bent. A display substrate of the display device may be easily damaged physically during a manufacturing process thereof. In order to prevent this, a bottom protecting film is attached under the display substrate.

The bottom protecting film is rolled around a film roll during the manufacturing process thereof and is cut at a predetermined interval while being released from the film roll to be input into a lamination process of attaching the bottom protecting film to the display substrate.

However, the cut bottom protecting film has a curl that a portion thereof is bent. The curl easily causes a defect during the lamination process in which the bottom protecting film and a lower substrate are aligned with each other and are attached to each other.

The curl more seriously occurs in the bottom protecting film positioned in the vicinity of a core of the film roll and rolled therearound and seriously occurs as a length of the bottom protecting film rolled around a film pole is long.

A portion at which the bottom protecting film does not contact the display substrate is present between a portion of the bottom protecting film at which a curl occurs and the display substrate contacting the portion, such that a friction force between the bottom protecting film and the display substrate may be reduced. Therefore, a slip phenomenon that the display substrate is slid may occur and uniformity of a sealed position may be degraded.

The above information disclosed in this Background section is only for enhancement of understanding of the background of the described technology and therefore it may contain information that does not form the prior art that is already known in this country to a person of ordinary skill in the art.

### SUMMARY OF THE INVENTION

The present disclosure has been made in an effort to provide an apparatus for preventing a curl in a bottom protecting film for a display device capable of minimizing the occurrence of a curl in a bottom protecting film to prevent a slip phenomenon of a display substrate during a lamination process and secure uniformity of a sealed position.

An embodiment provides an apparatus for preventing a curl in a bottom protecting film for a display device. The apparatus includes a working table on which the bottom protecting film is mounted, and a plurality of pressing apparatuses which is spaced apart from the working table and presses an edge part of the bottom protecting film. The plurality of pressing apparatuses includes a corner pressing apparatus which presses a corner of the edge part of the bottom protecting film and a side pressing apparatus which presses a longitudinal side part of the edge part of the bottom protecting film.

The pressing apparatus may include a contact pad which contacts and presses a top surface of the edge part of the bottom protecting film, a transfer part which transfers a temporary pressure to the contact pad; and a support part which supports the transfer part.

The contact pad may include a static electricity preventing layer which contacts the bottom protecting film, and a contact support layer which is disposed on the static electricity preventing layer.

The contact pad of the plurality of pressing apparatuses may include a corner contact pad which contacts a corner part of the edge part of the bottom protecting film, and a side contact pad which contacts a longitudinal side part of the edge part of the bottom protecting film.

The side contact pad may have a contact area larger than that of the corner part contact pad.

The transfer part of the pressing apparatus may include a plurality of branch parts having a straight shape and a folding part which connects the adjacent branch parts with each other and switches a direction of the branch part.

Another embodiment provides an apparatus for preventing a curl in a bottom protecting film for a display device. The apparatus includes a tray which has an opening in which a bottom protecting film is disposed, and a plurality of clamping apparatuses which is disposed on an inner side wall formed in the opening of the tray and clamps an edge part of the bottom protecting film. The plurality of clamping apparatuses includes a corner clamping apparatus which clamps a corner part of the edge part of the bottom protecting film and a side part clamping apparatus which clamps a longitudinal side part of the edge part of the bottom protecting film.

The clamping apparatus may include a clamper which contacts and clamps the edge part of the bottom protecting film, and a clamping groove which is disposed on the inner side wall of the tray and is inserted with the edge part of the bottom protecting film.

The apparatus for preventing a curl in a bottom protecting film for a display device may further include a sensor which is disposed in the clamping groove of the tray. The senor senses the bottom protecting film to control the clamping of the clamper.

The clamper may include a static electricity preventing layer which contacts the bottom protecting film, and a contact support layer which supports the static electricity preventing layer.

The clamper of the plurality of clamping apparatuses may include a corner clamper which contacts a corner part of the edge part of the bottom protecting film, and a side clamper which contacts a longitudinal side part of the edge part of the bottom protecting film.

The side clamper may have a contact area larger than that of the corner clamper.

According to the embodiments, the apparatus for preventing a curl in a bottom protecting film for a display device can use the plurality of pressing apparatuses or the plurality of clamping apparatuses to press the edge portion of the bottom protecting film and align the display substrate to laminate the bottom protecting film and the display substrate, thereby preventing the slip phenomenon of the display substrate and securing the uniformity of the sealed position.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an oblique view of an apparatus for preventing a curl in a bottom protecting film for a display device according to a first embodiment of the present invention;

FIG. 2 is a plan view of a bottom protecting film for a display device;

FIG. 3 is an enlarged oblique view of a side pressing apparatus of the apparatus for preventing a curl in a bottom protecting film for a display device according to the first embodiment;

FIG. 4 is an oblique view of an apparatus for preventing a curl in a bottom protecting film for a display device according to a second embodiment of the present invention;

FIG. 5 is a cross-sectional view taken along line V-V of FIG. 4; and

FIG. 6 is a cross-sectional view taken along line VI-VI of FIG. 4.

### DETAILED DESCRIPTION OF THE INVENTION

Hereinafter, the present disclosure will be described more fully hereinafter with reference to the accompanying drawings, in which exemplary embodiment are shown. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

In addition, the size and thickness of each configuration shown in the drawings are arbitrarily shown for understanding and ease of description, but the present invention is not limited thereto.

In the drawings, the thickness of layers, films, panels, regions, etc., are exaggerated for clarity. In the drawings, for understanding and ease of description, the thickness of some layers and areas is exaggerated. It will be understood that when an element such as a layer, film, region, or substrate is referred to as being “on” another element, it can be directly on the other element or intervening elements may also be present.

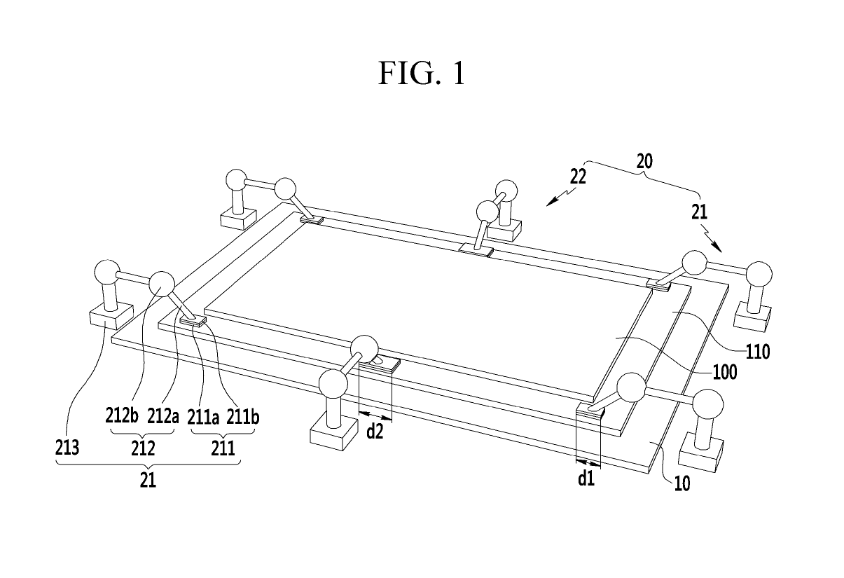

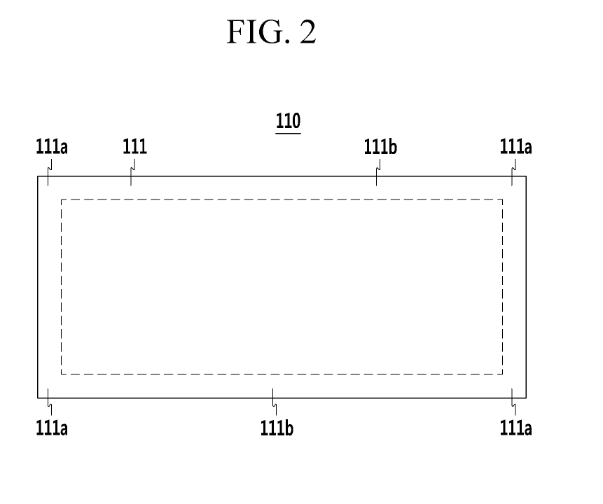

Hereinafter, an apparatus for preventing a curl in a bottom protecting film for a display device according to a first embodiment will be described in detail with reference to FIGS. 1 and 2.

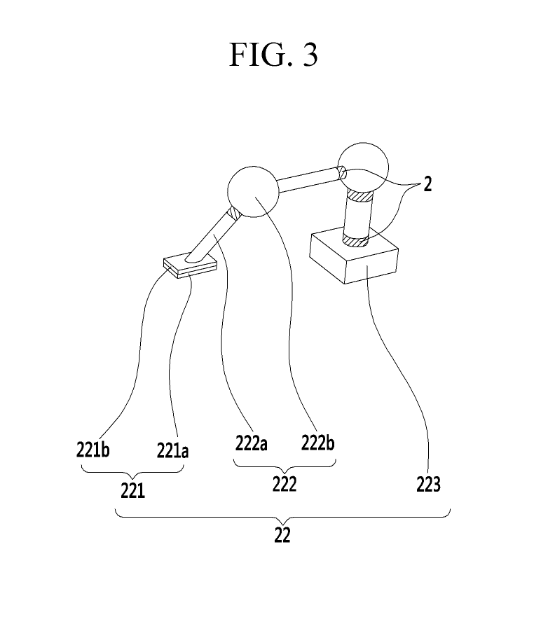

FIG. 1 is an oblique view of an apparatus for preventing a curl in a bottom protecting film for a display device according to a first embodiment, FIG. 2 is a plan view of a bottom protecting film for a display device, and FIG. 3 is an enlarged oblique view of a pressing apparatus of the apparatus for preventing a curl in a bottom protecting film for a display device according to the first embodiment.

As illustrated in FIGS. 1 to 3, the apparatus for preventing a curl in a bottom protecting film for a display device according to the first embodiment includes a working table 10 on which a bottom protecting film 110 is mounted and a plurality of pressing apparatuses 20 which is spaced apart from the working table 10 and presses an edge part 111 of the bottom protecting film 110.

When the apparatus for preventing a curl in a bottom protecting film for a display device uses the pressing apparatus 20 to press the edge part 111 of the bottom protecting film 110, the working table 10 contacts a bottom surface of the edge part 111 of the bottom protecting film 110 to serve to support the edge part 111. A display substrate 100 configured of a flexible substrate, and the like, is mounted on the bottom protecting film 110. The bottom protecting film 110 is formed to be larger than the display substrate 100, such that the edge part 111 of the bottom protecting film 110 may be exposed by the display substrate 100 and be accessible by the pressing apparatus 20.

The plurality of pressing apparatuses 20 includes a corner pressing apparatus 21 which presses a corner part 111a of the edge part 111 of the bottom protecting film 110 and a side pressing apparatus 22 which presses a longitudinal side part 111b of the edge part 111 of the bottom protecting film 110.

The corner pressing apparatus 21 includes a corner contact pad 211 which contacts and presses a top surface of the edge part 111 of the bottom protecting film 110, a transfer part 212 which transfers a temporary pressure to the corner contact pad 211, and a support part 213 which supports the transfer part 212.

The corner contact pad 211 directly contacts the corner part 111a of the edge part 111 of the bottom protecting film 110 to press the corner part 111a, thereby preventing a curl from occurring in the corner part 111a of the bottom protecting film 110. The corner contact pad 211 includes a static electricity preventing layer 211a which contacts the bottom protecting film 110 to prevent static electricity from occurring and a contact support layer 211b which is disposed on a static electricity preventing layer 211a and is made of a stainless steel (steel use stainless (SUS)) material having a predetermined weight for physical pressing action.

The transfer part 212 includes a plurality of branch parts 212a which has a straight shape and is made of a solid stainless steel (steel use stainless (SUS)) material and a folding part 212b which connects the adjacent branch parts 212a with each other and switches a direction of the branch parts 212a. The branch part 212a includes a fastening part (not shown) so that the branch part 212a may be connected to the folding part 212b and the support part 213. The fastening part may be a screw and a nut. As such, the transfer part 212 that can be folded and unfolded is mounted, thereby maximizing spatial utility.

Likewise the corner pressing apparatus 21, the side pressing apparatus 22 includes a side contact pad 221 which contacts a longitudinal side part 111b of the edge part 111 of the bottom protecting film 110, a transfer part 222 which transfers the temporary pressure to the side contact pad 221, and a support part 223 which supports the transfer part 222.

The side contact pad 221 contacts the longitudinal side part 111b of the edge part 111 of the bottom protecting film 110 and the longitudinal side part 111b has a curl having a larger area than that of a curl of the corner part 111a, such that the side contact pad 221 may have a larger area than the corner contact pad 211. To this end, a length d2 of the side contact pad 221 may be larger than a length d1 of the corner contact pad 211.

The side contact pad 221 includes a static electricity preventing layer 221a which contacts the bottom protecting film 110 and a contact support layer 221b which is disposed on the static electricity preventing layer 221a.

The transfer part 222 of the side pressing apparatus 22 includes a plurality of branch parts 222a having a straight shape and a folding part 222b which connects the adjacent branch parts 222a and switches a direction of the branch parts 222a. The branch part 222a includes a fastening part 2 so that the branch part 222a may be connected to the folding part 222b and the support part 223. The fastening part 2 may be a screw and a nut. As such, the transfer part 222 that can be folded and unfolded is mounted, thereby maximizing spatial utility.

As such, the edge part 111 of the bottom protecting film 110 is pressed by the plurality of pressing apparatuses 20 to prevent a curl from occurring in the bottom protecting film 110 and then the display substrate 100 is aligned to laminate the bottom protecting film 110 and the display substrate 100, thereby preventing the slip phenomenon of the display substrate and securing the uniformity of the sealed position.

Meanwhile, the first embodiment uses the pressing apparatus to prevent the curl from occurring in the bottom protecting film for the display device, and a second embodiment using a clamping apparatus to prevent a curl from occurring in the bottom protecting film for the display device can also be performed.

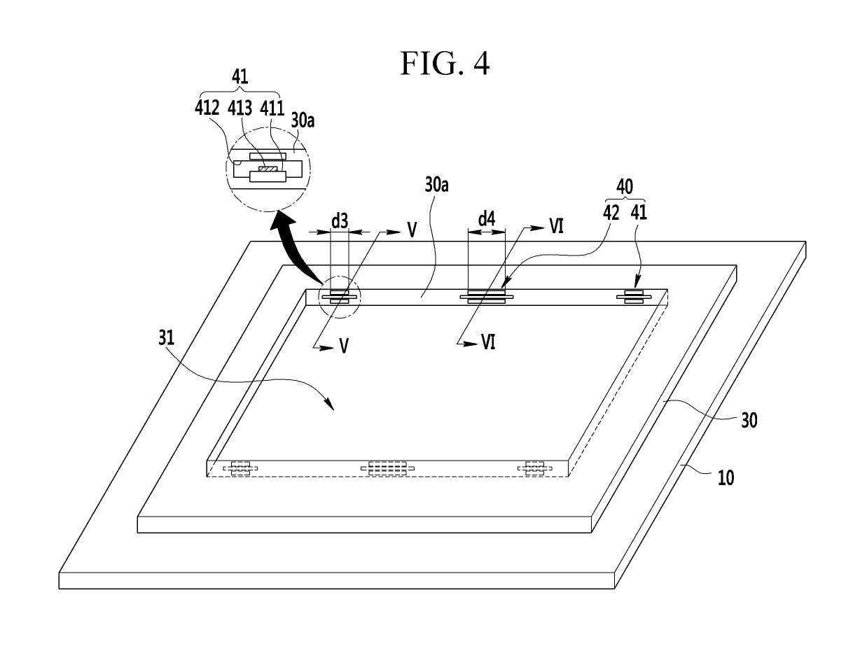

Hereinafter, an apparatus for preventing a curl in a bottom protecting film for a display device according to the exemplary embodiment will be described in detail with reference to FIGS. 4 to 6.

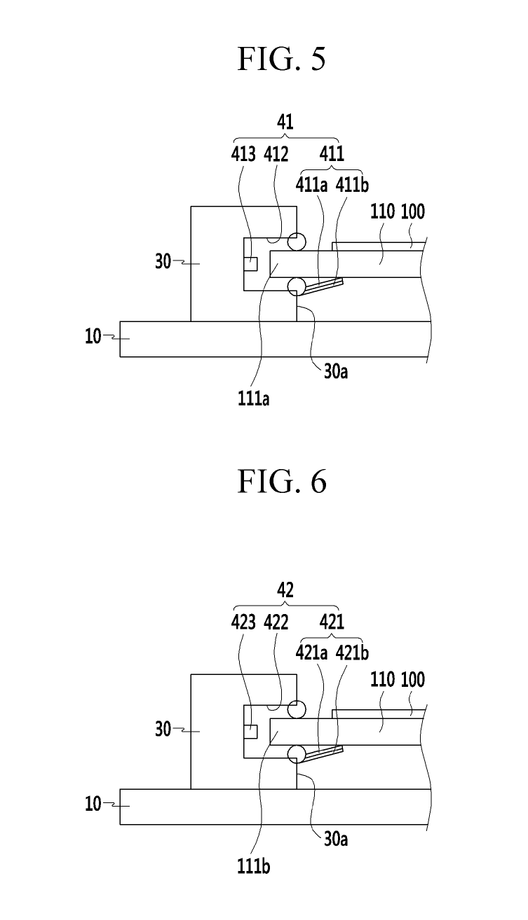

FIG. 4 is an oblique view of an apparatus for preventing a curl in a bottom protecting film for a display device according to a second embodiment, FIG. 5 is a cross-sectional view taken along line V-V of FIG. 4, and FIG. 6 is a cross-sectional view taken along line VI-VI of FIG. 4.

As illustrated in FIGS. 4 to 6, the apparatus for preventing a curl in a bottom protecting film for a display device according to the second embodiment includes a tray 30 which has an opening 31 in which the bottom protecting film 110 is disposed and a plurality of clamping apparatuses 40 which is disposed on an inner side wall 30a formed in the opening 31 of the tray 30 and clamps the edge part 111 of the bottom protecting film 110.

The tray 30 is mounted on the working table 10 and the working table 10 may be provided with a fixation part (not illustrated) which fixes the tray 30.

The plurality of clamping apparatuses 40 includes a corner clamping apparatus 41 which presses the corner part 111a of the edge part 111 of the bottom protecting film 110 and a side clamping apparatus 42 which presses the longitudinal side part 111b of the edge part 111 of the bottom protecting film 110.

The corner clamping apparatus 41 includes a corner clamper 411 which contacts and clamps the corner part 111a of the bottom protecting film 110, a clamping groove 412 which is disposed on the inner side wall 30a of the tray 30 and is inserted with the corner part 111a of the bottom protecting film 110, and a sensor 413 which is mounted in the clamping groove 412.

The sensor 413 senses the bottom protecting film 110 to control the clamping of the corner clamper 411. That is, the sensor 413 senses the bottom protecting film 110 to allow the corner clamper 411 to clamp the bottom protecting film 110.

The corner clamper 411 includes a static electricity preventing layer 411a which contacts the bottom protecting film 110 and a contact support layer 411b which supports the static electricity preventing layer 411a, in which the static electricity preventing layer 411a contacts the corner part 111a of the edge part 111 of the bottom protecting film 110.

Likewise the corner clamping apparatus 41, the side clamping apparatus 42 includes a side clamper 421 which contacts and clamps the longitudinal side part 111b of the edge part 111 of the bottom protecting film 110, a clamping groove 422 which is disposed on the inner side wall 30a of the tray 30 and is inserted with the longitudinal side part 111b of the bottom protecting film 110, and a sensor 423 which is mounted in the clamping groove 422.

The side clamper 421 contacts the longitudinal side part 111b of the edge part 111 of the bottom protecting film 110 and the longitudinal side part 111b has a curl having a larger area than that of a curl of the corner part 111a, such that the side clamper 421 may have a larger contact area than that of the corner clamper 411. To this end, a length d4 of the side clamper 421 may be larger than a length d3 of the corner clamper 411.

As such, the edge part 111 (refer to FIG. 2) of the bottom protecting film 110 is pressed by the plurality of clamping apparatuses 40 to prevent a curl from occurring in the bottom protecting film 110 and then the display substrate 100 is aligned to laminate the bottom protecting film 110 and the display substrate 100, thereby preventing the slip phenomenon of the display substrate and securing the uniformity of the sealed position.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. An apparatus for preventing a curl in a bottom protecting film for a display device, the apparatus comprising:
a working table on which a bottom protecting film is mounted; and
a plurality of pressing apparatuses disposed spaced-apart from the working table and pressing an edge part of the bottom protecting film, the plurality of pressing apparatuses including:
a corner pressing apparatus which presses a corner part of the edge part of the bottom protecting film; and
a side pressing apparatus which presses a longitudinal side part of the edge part of the bottom protecting film.

2. The apparatus of claim 1, wherein the pressing apparatus includes:
a contact pad contacting and pressing a top surface of the edge part of the bottom protecting film;
a transfer part transferring a temporary pressure to the contact pad; and
a support part supporting the transfer part.

3. The apparatus of claim 2, wherein the contact pad includes:
a static electricity preventing layer contacting the bottom protecting film; and
a contact support layer disposed between the static electricity preventing layer and the transfer part.

4. The apparatus of claim 3, wherein the contact pad of the plurality of pressing apparatuses includes:
a corner contact pad contacting a corner part of the edge part of the bottom protecting film; and
a side contact pad contacting a longitudinal side part of the edge part of the bottom protecting film.

5. The apparatus of claim 4, wherein a contact area of the side contact pad is greater than a contact area of the corner contact pad.

6. The apparatus of claim 2, wherein the transfer part of the pressing apparatus includes a plurality of branch parts having a straight shape and a folding part which connects adjacent branch parts with each other and switches a direction of the branch part.

7. An apparatus for preventing a curl in a bottom protecting film for a display device, the apparatus comprising:
a tray including an opening in which a bottom protecting film is disposed; and
a plurality of clamping apparatuses disposed on an inner side wall formed in the opening of the tray and clamps an edge part of the bottom protecting film, the plurality of clamping apparatuses including:
a corner clamping apparatus clamping a corner part of the edge part of the bottom protecting film; and
a side clamping apparatus clamping a longitudinal side part of the edge part of the bottom protecting film.

8. The apparatus of claim 7, wherein the clamping apparatus includes:
a clamper contacting and clamping the edge part of the bottom protecting film; and
a clamping groove disposed on the inner side wall of the tray and inserted with the edge part of the bottom protecting film.

9. The apparatus of claim 8, further comprising a sensor disposed in the clamping groove of the tray, sensing the bottom protecting film, and providing a signal to control the clamper.

10. The apparatus of claim 9, wherein the clamper includes:
a static electricity preventing layer contacting the bottom protecting film; and
a contact support layer supporting the static electricity preventing layer.

11. The apparatus of claim 10, wherein the clamper of the plurality of clamping apparatuses includes:
a corner clamper contacting a corner part of the edge part of the bottom protecting film; and
a side clamper contacting a longitudinal side part of the edge part of the bottom protecting film.

12. The apparatus of claim 11, wherein a contact area of the side clamper is greater than a contact area of the corner clamper.
